(19) United States
(12) Patent Application Publication
(10) Pub. No.: US 2011/0210867 A1
(43) Pub. Date: Sep. 1, 2011

(54) System And Method For Improved Vehicle Safety Through Enhanced Situation Awareness Of A Driver Of A Vehicle

(75) Inventor: Shmuel Zalman Benedikt, Tel Aviv (IL)

(73) Assignee: ASER RICH LIMITED, London (GB)

(21) Appl. No.: 13/128,971

(22) PCT Filed: Nov. 12, 2009
(86) PCT No.: PCT/IL09/01065

§ 371 Date: May 12, 2011

Related U.S. Application Data
(60) Provisional application No. 61/114,108, filed on Nov. 13, 2008.
(60) Provisional application No. 61/250,880, filed on Oct. 13, 2009.

(51) Int. Cl. G08G 1/09

(52) U.S. Cl. 340/905

(57) ABSTRACT

The present invention provides a situation awareness system of a driver of a vehicle in a multi-vehicle environment, said system comprising: a. a remote central server communicatively connected to a vehicle, comprising: i. a server computer comprising a CPU, a memory, and an operating system; ii. a wireless server transceiver; iii. databases within said server computer; iv. server applications within said server computer; b. a vehicle subsystem installed in a vehicle with a driver, comprising: i. an vehicle computer having a CPU, a memory, and an operating system; ii. sensors; iii. vehicle databases; iv. a vehicle transducer to interrogate external environmental responders about the state of the environment; v. a wireless vehicle transceiver; vi. vehicle applications within said vehicle computer; vii. a situation assessment application,

### FIELD OF THE INVENTION

The present application is directed to a system and method for improved vehicle safety by assisting a driver of the vehicle to attain enhanced situation awareness.

### BACKGROUND OF THE INVENTION

Situation awareness is defined as the perception of environmental elements within a volume of time and space, the comprehension of their meaning, and the projection of their status in the near future. It is also a field of study concerned with perception of the environment critical to decision-makers in complex, dynamic, high-tension, high-risk areas such as aviation, air traffic control, hospital emergency operations and military command and control.

Situation awareness involves being aware of what is happening around you to understand how information, events, and your own actions will impact your objectives, both now and in the near future. Lacking situation awareness or having inadequate situation awareness has been identified as one of the primary factors in all the accidents attributed to human error. Situation awareness is especially (but not exclusively) important in work domains where the information flow can be quite high and bad decisions may lead to serious consequences (e.g., piloting an airplane, functioning as a soldier in a hostile environment, treating critically ill or injured patients). Situational awareness could be easily applied to an ordinary but nevertheless complex and demanding task such as driving a land-based motor vehicle such as a family car at relatively high speeds along a highway or a roadway at night, surrounded closely by other vehicles controlled by complete strangers that also move at relatively high speeds (slower or faster than the family car) in the same and the opposite direction and whose driving-related behavior potentially could be unpredictable and dangerous. The surrounding vehicles must be related to in the proper manner. The surrounding vehicles may differ in size, weight and dimension. They could be much bigger, higher and heavier than the family vehicle and those should be related to in a manner which is different from relating to the vehicles closer in size, weight and dimensions to the family car). If we add to this the fact that there is a good chance than the family car carries the entire close family of the driver, such as his wife and his children whose lives are literally in his hands, there could be no scorning the idea of applying situation-awareness related ideas to the act of driving a family car on an extremely busy confusedly-lit, confusedly-signed highway; or in the congested streets of a city where, in addition, a plurality of completely strangers on foot (pedestrians) surround the vehicle and milling confusedly about it (from the driver's point of view) in a potentially unexpected and dangerous manner.

Having complete, accurate and up-to-the-minute situational awareness is essential where technological and situational complexity on the human decision-maker is a concern. Applying the above sentence to the act of driving of a ground vehicle such as a family car could be considered by some an overstatement but the technological and situational complexities are still there nonetheless although in a substantially reduced manner.

Just as mistakes are made in the highly complex, dynamic, high-tension high-risk areas of piloting, soldiering, and the like, mistakes could be made also during the act of driving a ground vehicle and the consequent results could be just as horrific as those made in the complex, high-tension high-risk areas. The wiping out of entire families in seconds as a result of a potentially avoidable road accident could be as traumatic as the passing away of a single patient as a result of a mistake made by a medical team during a surgical procedure.

It is important to distinguish the term situation awareness, as a state of knowledge, from the processes used to achieve that state such as assessment processes. These assessment processes, which may vary widely among individuals and contexts, are the processes of achieving, acquiring, or maintaining situational awareness. Situational awareness is viewed as a state of knowledge, and assessment processes as the processes used to achieve that knowledge.

A set of well-defined, highly-organized yet dynamic knowledge structures developed over time from experience are one of the prerequisites for achieving situational awareness. The volume of available data inherent in complex operational environments can overwhelm the capability of non-experienced decision makers to attend, process, and integrate this information efficiently, resulting in information overload and negatively impacting their situational awareness. In contrast, experienced decision makers assess and interpret the current situation and select an appropriate action based on conceptual patterns stored in their long-term memory as knowledge structures. Cues in the environment activate these structures, which in turn guide their decision making process.

In other words, to provide a driver of a ground vehicle with enhanced situational awareness the following are needed:

Enhanced or high-quality information should be made available to the driver in real-time (or nearly real-time) to add to his situational awareness or to his state of knowledge. Today only low-quality low-resolution information (if available) is collected by using primarily the human visual sensing apparatus (i.e. eyes) to perceive a traffic sign, a traffic light, the state of the traffic light, the distance from the nearest vehicle in front, the distance to the borders of a road lane, the distance from the shoulders, the output of a GPS device and the like. Low-level, low-resolution information is characterized by its inexactitude. For example, the driver could perceive visually a traffic light but due to environmental conditions (fog, rain, blinding sun, and the like) he might misinterpret the distance thereof and more importantly misjudge the color thereof. Additional low-level and inexact information is provided to the driver by his brain and more particularly by his memory and memory processes. Due to natural limitations of these processes the driver might misremember the distance between the moving vehicle and a required exit ramp from the highway and therefore miss a required exit or might misremember the correct turn or the correct target location within a populated area. In contrast with the low-level and low-resolution information the driver should get enhanced high-level, high-resolution information which is characterized by relative exactitude. The driver should receive exact data concerning the environmental conditions, such as the location of the vehicle, the location and state of traffic lights, the road geometry (intersections, exit ways, entry ways, and number of lanes), and geographic data such as roadmaps, traffic works being executed, and the like. The driver further should receive exact data concerning the dynamically changeable location-specific traffic rules, such as speed limits in a specific area, “No entry” or “No U-turn” instructions or parking rules in a metropolitan area.

Assistance should be provided to the driver in efficiently assessing, interpreting, processing, and successfully integrating the collected information into appropriate knowledge structures. Again due the natural limitations of the human brain the correct results provided by the above processes when performed by the human brain are far from perfect. Without external assistance the driver might perceive a traffic sign and yet not quite remember of meaning thereof. Furthermore, the volume of the available information could overwhelm the capability of non-experienced drivers to attend, process, and integrate this information efficiently. This might result in information overload and negatively impacting their situational awareness. Thus, assistance should be provided to a driver under extreme conditions (a near collision situation and the like) in the performance of situation assessment and situation interpretation.

Assistance to the driver should include information overload reduction or optimistically information overload elimination by providing under extreme conditions the option of automatic vehicle-specific emergency operations that should be executed without the participation of the driver. Assistance to the driver should further include measuring and estimating the situation awareness of the driver himself where the measurements are based on the driver's present device handling actions, past driving-related record, present physical condition, past physical characteristics, medical history, current health condition and the like.

Just as in the domains of the high-risk, high-tension work areas such as aviation, air traffic control, hospital emergency operations and military command and control, situation awareness could be extremely important in the area of ground vehicle driving. The great majority of road accidents are the direct result of the lack of situational awareness or an inadequacy of the situational awareness. Practically a situation awareness-related problem is caused by a specific failure in the collection of relevant information (a failure to see a traffic sign indicating the proximity of an intersection) and/or a failure in the performance of the assessment processes (bad judgment concerning distance of the vehicle from the intersection).

Considering the enormous cost of road accidents both in the human and the financial aspects thereof it would be easily perceived that a novel and comprehensive system and method are needed to reduce as much as possible the number of road accidents and consequently the number of victims. Other objects, features and advantages of the present invention are apparent from the following detailed description when read in conjunction with the attached drawings and appended claims.

### SUMMARY OF THE INVENTION

The present invention discloses a situation awareness system of a driver of a vehicle in a multi-vehicle environment. The system comprises:
a. At least one remote central server communicatively connected to the at least one vehicle. The server comprises:
   i. A server computer which comprises a CPU, a memory, and an operating system.
   ii. At least one wireless server transceiver.
   iii. A plurality of server databases within the server computer.
   iv. A plurality of server applications within the server computer adapted to manage the plurality of server databases and to control the wireless server transceiver.
b. At least one vehicle subsystem installed in a vehicle with a driver. The subsystem comprises:
   i. An vehicle computer having a CPU, a memory, and an operating system.
   ii. A plurality of sensors adapted to collect information about the state of the vehicle to identify the driver, and to collect information about the state of the driver.
   iii. A plurality of vehicle databases within the vehicle computer.
   iv. At least one vehicle transducer to interrogate external environmental responders about the state of the environment.
   v. A wireless vehicle transceiver adapted to communicate with the at least one remote central server.
   vi. A plurality of vehicle applications within the vehicle computer adapted to manage the plurality of vehicle databases and to control the wireless vehicle transceiver.
   vii. A situation assessment application adapted to collect and analyze the collected information from the plurality of sensors, the databases of the remote central server, and the plurality of vehicle databases, and to register the analyzed information into data structures, wherein the situation assessment application is based on at least one situation assessment mathematical function.

It is within the essence of the invention wherein the vehicle subsystem further comprises a user interface warning device which is adapted to present the data structures in a user friendly manner, and thereby to enhance the situation awareness of the driver.

The present invention also discloses a situation awareness system, wherein the wireless server transceiver is adapted to establish and maintain wireless communication between the remote central server and: (a) the at least one vehicle, (b) other at least one remote server, and (c) external authorities.

The present invention also discloses a situation awareness system, the situation assessment mathematical function is adapted to assess the situation by using the statistics of accidents received from the external authorities. The statistics is registered in the server databases and the vehicle databases.

The present invention also discloses a situation awareness system, which further comprises a plurality of external environmental responders removably attached to specific objects in the environment, wherein the responders are adapted to respond to an interrogating signal generated by the vehicle transducer and to provide information regarding the objects.

The present invention also discloses a situation awareness system, wherein the objects are selected from a group consisting of: standard road components, traffic signs, traffic lights, landscape features, components in the road geometry, borders of lanes, temporal vehicles, or any combination thereof.

The present invention also discloses a situation awareness system, wherein the plurality of server databases are selected from a group consisting of: (a) an environmental server database adapted to store objects and features that could influence on the driving behavior of the driver, (b) a geographical server database adapted to store map records, (c) accidents server database adapted to store the location of past accidents and the number of accidents in the location, (d) a trip information server database adapted to store the trip history of the vehicle and the driver, and (e) a driver-specific history server database to store the profile of each the driver of the vehicle.

The present invention also discloses a situation awareness system, wherein the environmental server database comprises information selected from a group consisting of: outstanding road events, predetermined speed limits, temporary speed limits, traffic conditions, different types of traffic signs, traffic lights, bridges, exit and entry ramps, blocked lanes, separation lines between lanes, borders of lanes, works on the road, unexpected obstacles on the road, weather-related conditions, temperature limits of the vehicle or any combination thereof.

The present invention also discloses a situation awareness system, wherein the driver-specific history server database comprises information selected from a group consisting of: negative driving-related behavior of the vehicle and the driver, past records of the vehicle and the driver, medical history and current condition of the driver, or any combination thereof.

The present invention also discloses a situation awareness system, wherein the trip information server database comprises information selected from a group consisting of: time-continuous location records of the vehicle, time-continuous records of information received from the plurality of sensors, or any combination thereof.

The present invention also discloses situation awareness system, wherein the plurality of server databases are able to be synchronized with databases related to authorities selected from a group consisting of: police, fire services, municipal, health, first aid, road infrastructure companies, military, or any combination thereof.

The present invention also discloses a situation awareness system, wherein the plurality of vehicle databases are selected from a group consisting of: (a) an environmental vehicle database adapted to store objects and features that could influence on the driving behavior of the driver, and the information received from the environmental responders, (b) a geographical vehicle database adapted to store map records, (c) accidents vehicle database adapted to store the location of past accidents and the number of accidents in the location, (d) a trip information vehicle database adapted to store the trip history of the vehicle or the driver, and (e) a driver-specific history vehicle database to store the profile of each the driver of the vehicle.

The present invention also discloses a situation awareness system, wherein the environmental vehicle database comprises the geographical location of information selected from a group consisting of: outstanding road events, predetermined speed limits, temporary speed limits, traffic conditions, different types of traffic signs, traffic lights, bridges, exit and entry ramps, blocked lanes, separation lines between lanes, borders of lanes, works on the road, unexpected obstacles on the road, weather-related conditions, or any combination thereof.

The present invention also discloses a situation awareness system, wherein the trip information vehicle database comprises information selected from a group consisting of: time-continuous location records of the vehicle, time-continuous records of information received from the plurality of sensors, or any combination thereof.

The present invention also discloses a situation awareness system, wherein the information regarding the objects received from the responders is compared to the data in the environmental vehicle database, and in case of detection of previously unknown information regarding the objects, the unknown information is registered in the environmental vehicle database.

The present invention also discloses a situation awareness system, wherein the driver-specific history vehicle database comprises information selected from a group consisting of: negative driving-related behavior of the vehicle or the driver, past records of the vehicle or the driver, medical history and current condition of the driver, or any combination thereof.

The present invention also discloses a situation awareness system, wherein the central server and the vehicle subsystem further comprise a synchronization application adapted to synchronize the vehicle databases with the server databases in a predetermined time interval, according to a predetermined radius around the vehicle, or according to a specific important event, such that at least one of the following operations is performed: (a) the environmental vehicle database is synchronized with the environmental server database, (b) the geographical vehicle database is synchronized with the geographical server database, (c) the accidents vehicle database is synchronized with the accidents server database, (d) the trip information vehicle database is synchronized with the trip information server database, (e) the driver-specific history vehicle database is synchronized with the driver-specific history server database.

The present invention also discloses a situation awareness system, wherein the plurality of sensors is selected from a group consisting of: driver identification sensor, at least one speed sensor, at least one proximity sensor, sensors of air pressure in the wheels, at least one air-bag activation sensor, at least one sensor to detect presence of alcohol in the air of the vehicle, sensors to verify that both hands are one the steering wheel of the vehicle, at least one temperature sensor, at least one video camera, at least one pressure sensor within at least one seat of the vehicle to detect presence of a passenger, sensors to notify regarding a periodical vehicle of the vehicle, belt sensors, fuel sensor, water/oil sensor, at least one sensor to analyze the air in the vehicle to detect a sleepy and/or a drunk driver.

The present invention also discloses a situation awareness system, wherein the vehicle subsystem is further adapted to register the collected information from the plurality of sensors in the trip information vehicle database.

The present invention also discloses a situation awareness system, which further comprises a GPS navigation system, wherein situation assessment application is further adapted to collect and analyze the collected information from the GPS navigation system; further wherein the GPS navigation system is adapted to be synchronized with a database selected from a group consisting of: the geographical vehicle database, the geographical server database, or any combination thereof.

The present invention also discloses a situation awareness system, wherein the vehicle subsystem is adapted to be activated and deactivated by two consequent pressings on the winker of the vehicle.

The present invention also discloses a situation awareness system, wherein the vehicle subsystem is adapted to be at least partially activated and deactivated by external authorities selected from a group consisting of: police, fire services first aid, or any combination thereof.

The present invention also discloses a situation awareness system, which further comprises an automatic vehicle control system adapted to limit and to reduce the speed of the vehicle in an emergency case which is detected by the situation assessment application, wherein the state of vehicle is automatically changed according to the emergency case.

The present invention also discloses a situation awareness system, wherein the automatic vehicle control system is adapted to limit and to reduce the speed of the vehicle when the speed of the vehicle, measured by the speed sensor, is over the speed limit registered in the environmental vehicle database.

The present invention also discloses a situation awareness system, wherein the automatic vehicle control system is adapted to limit and to reduce the speed of the vehicle when the vehicle is located in an area with a number of past accidents which is higher than a predetermined accidents threshold, according to the registered past accidents in the accidents vehicle database.

The present invention also discloses a situation awareness system, wherein the of applications within the server computer which further comprises an emergency condition assessment application adapted to detect emergency conditions of the vehicle by analyzing the trip information server database.

The present invention also discloses a situation awareness system, wherein the situation assessment application is further adapted to calculate the risk of by-passing other vehicles.

The present invention also discloses a situation awareness system, wherein the plurality of applications within the server computer further comprises a driver assessment application adapted to: (a) assess the behavior of the driver or the vehicle on the road by analyzing the plurality of server databases (b) inform the driver of the vehicle in case of a negative behavior on the road (c) inform the police in case of negative behavior of the vehicle or of the driver on the road.

The present invention also discloses a situation awareness system, wherein the driver assessment application is further adapted to analyze the plurality of server databases to understand the circumstances which led to an accident and to receive the history of the vehicle or the driver.

The present invention also discloses a situation awareness system, wherein the driver assessment application is further adapted to inform an insurance company regarding the assessed behavior of the driver or the vehicle.

The present invention also discloses a situation awareness system, wherein the plurality of applications further comprises an automatic parking system, the automatic parking system is adapted to: (a) detect that the vehicle is parking in a parking place by analyzing the trip information vehicle database (b) inform the driver of the vehicle regarding the legality of the parking of the vehicle (c) charge a predetermined parking-account of the driver in case of legal parking (d) inform parking authorities in case of illegal parking.

The present invention also discloses a situation awareness system, wherein the trip information server database and the trip information vehicle database are further adapted to register at least one message received from a first vehicle, the message can be transmitted to a second vehicle and presented to the driver of the second vehicle by the user interface warning device, wherein the message is presented to the driver according to the authorizations of the driver of the first vehicle and the driver of the second vehicle.

The present invention also discloses a situation awareness system, further adapted to allow the driver of the vehicle to receive driving directions by calling to a customer center connected to the central server.

The present invention also discloses a situation awareness system, wherein the situation assessment application is adapted to detect the distance between at least two vehicles in the multi-vehicle environment by using means selected from a group consisting of: the geographical server database, the trip information server database, the environmental server database, the at least one proximity sensor, or any combination thereof.

The present invention also discloses a situation awareness system, wherein the situation awareness system further comprising a parking assisting application adapted to assist the driver of the vehicle to park the vehicle by using the at least one proximity sensor.

The present invention also discloses a situation awareness system, further comprising an automatic accident reporting system adapted to detect that an accident has occurred with the vehicle by analyzing the server databases and to report the authorities regarding accident events of the vehicle, the automatic accident reporting system further adapted to report details regarding the accident.

The present invention also discloses a method for enhancement of situation awareness of a driver of a vehicle in a multi-vehicle environment. The method comprises:
a. Obtaining a situation awareness system which comprises a vehicle subsystem and a remote central server.
b. Identifying the driver of the vehicle.
c. Collecting information by a plurality of sensors, the information is about the state of the vehicle and about the state of the driver.
d. Synchronizing the vehicle databases with the server databases in a predetermined time interval by a synchronization application, according to a predetermined radius around the vehicle, or according to a specific important and urgent event.
e. Managing the plurality of server databases and the plurality of vehicle databases and controlling the wireless server transceiver and the wireless vehicle transceiver by the server applications and the vehicle applications.
f. Interrogating external environmental responders about the state of the environment and registering the received information from the responders in the vehicle databases;
g. Analyzing the collected information received from the plurality of sensors, aid databases of the remote central server, and the plurality of vehicle databases, and registering the analyzed information into data structures, wherein the step of analyzing is by a situation assessment application based on at least one situation assessment mathematical function.
h. Presenting the data structures in a user friendly manner by a user interface warning device within the vehicle subsystem, and thereby enhancing the situation awareness of the driver.

The present invention also discloses a method for enhancement of situation awareness, which further comprises a step of establishing and maintaining wireless communication by the wireless server transceiver between the remote central server and (a) the at least one vehicle, (b) other at least one remote server, and (c) external authorities.

The present invention also discloses a method for enhancement of situation awareness, which further comprises a step of assessing the situation by the situation assessment mathematical function using the statistics of accidents received from the external authorities. The statistics is registered in the server databases and vehicle databases.

The present invention also discloses a method for enhancement of situation awareness, which further comprises a step of synchronizing the plurality of server databases with databases related to authorities selected from a group consisting of: police, fire services, municipal, health, first aid, road infrastructure companies, military, or any combination thereof.

The present invention also discloses a method for enhancement of situation awareness, which further comprises a step of synchronizing the GPS navigation system with a database selected from a group consisting of: the geographical vehicle database, the geographical server database, or any combination thereof.

The present invention also discloses a method for enhancement of situation awareness, which further comprises a step of activating and deactivating the system by two consequent pressings on the winker of the vehicle.

The present invention also discloses a method for enhancement of situation awareness, which further comprises a step of limit and reducing the speed of the vehicle in an emergency case which is detected by the situation assessment application, wherein the state of vehicle is automatically changed according to the emergency case.

### BRIEF DESCRIPTION OF THE FIGURES

In order to better understand the invention and its implementation in a practice, a plurality of embodiments will now be described, by way of non-limiting example only, with reference to the accompanying drawings, in which

FIG. 1 illustrates an exemplary schematic embodiment of the present invention.

FIG. 2 illustrates the preferred embodiment of the situation awareness system of the present invention.

FIG. 3 illustrates a schematic block diagram showing the components of a responder of the present invention.

FIG. 4 illustrates a schematic block diagram showing the data fields of the responder's message structure.

### DETAILED DESCRIPTION OF THE PREFERRED EMBODIMENTS

The present invention can be understood more readily by reference to the following detailed description, examples, drawings, and claims, and their previous and following description.

However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

The present invention concerns to a system and method for improving vehicle safety by enhancing the situation awareness of the driver of the vehicle. The system of the present invention is adapted to present in user-friendly manner high-quality and high-resolution critical information collected from various sources in real time. Nowadays, a driver of a vehicle is using low-quality and low-resolution information in order to making decision while driving the vehicle. This information, which is collected by his senses of vision and hearing and is analyzed by his brain, is very limited. In order to perform the right actions on the road, the driver has to be very concentrated, experienced, and sometimes also lucky. The system of the present invention is adapted to collect information from different sources which are usually not available to the driver, to integrate the information, to process the information, to interpret the information and to present it to the driver in real-time. By doing that, the system of the present invention will enhance the situation awareness of the driver, and will help him to make the right decisions on the road. Moreover, in critical situations, the system of the present invention will be able to automatically take control on the vehicle and for example to reduce the speed of the vehicle.

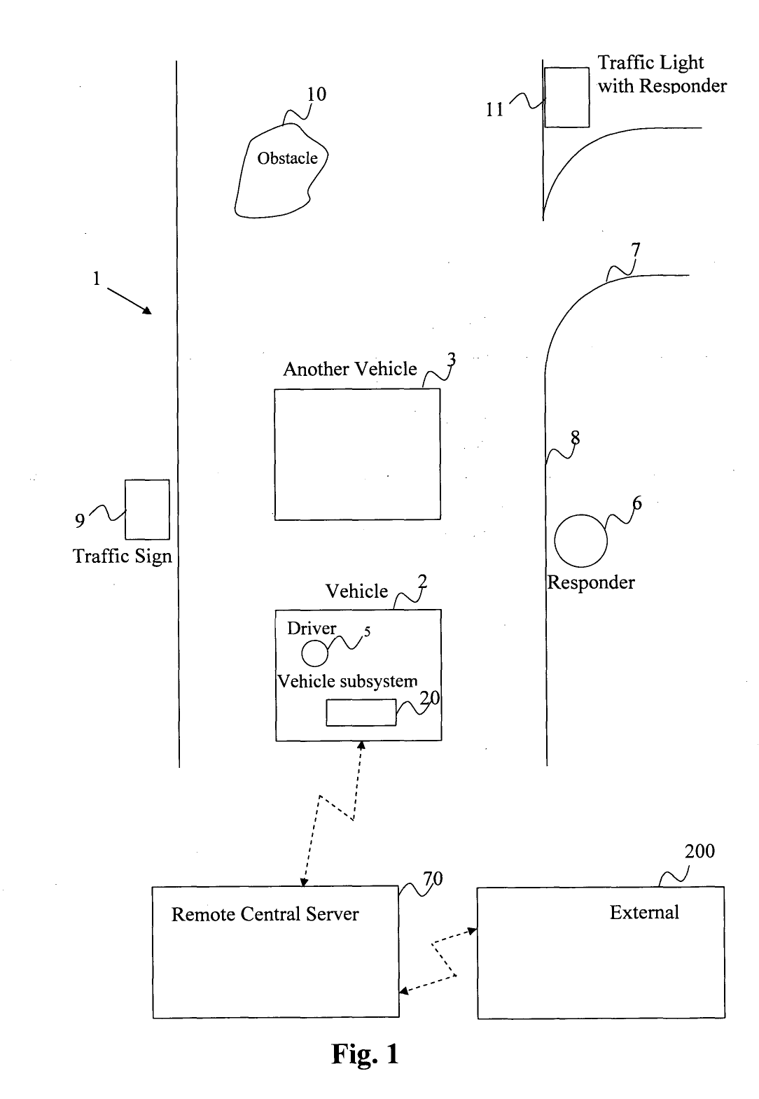

Reference is made now to FIG. 1 where illustrated an exemplary schematic embodiment of the present invention. This Figure shows a multi-vehicle environment 1 that is basically a roadway or a highway located in a specific geographic area. Environment 1 can comprise many vehicles, one, some or all of them are optionally connected to the system of the present invention. For example, vehicle 2 is connected to the system of the present invention, and vehicle 3 is not connected to the system of the present invention. Vehicle 2 may be any kind of land-based vehicle such as a private vehicle, a truck, a bus, an automobile, a motorcycle, a van, a bicycle, a train, etc. In the preferred embodiment of the present invention, vehicle 2 is a private vehicle driven by driver 5.

Environment 1 further comprises well-known fixed or temporary road features such as, for example, lane border 8, exit 7, traffic sign 9, obstacle 10. Moreover, environment 1 comprises responder 6 and traffic light with a responder 11. These responders are part of the system of the present invention, and are configured to be attached to specific objects in environment 1, such that information regarding the responders is transmitted to the system of the present invention. This information can be for example: the status of the lights in a traffic light, a location of a specific traffic sign, a massage to the driver regarding the traffic on the road, existence of obstacles on the road, etc. The responders are adapted to respond to an interrogating signal generated by vehicle 2 and to provide information regarding the objects they are attached to.

Vehicle 2 is equipped with a vehicle subsystem 20 which a first main part of the system of the present invention. Vehicle subsystem 20 is adapted to collect data from different sources as it will be detailed below, to analyze the data, and to present the summarized data to driver 5, in a user-friendly manner. One of the main sources of data is the remote central server 70. Vehicle subsystem 20 and remote central server 70 are connected to each other by wireless communication means such as: radio connection, cellular connection, internet connected, or any other well-known in the art communication manner. In a preferred embodiment of the present invention, remote central server 70 can be connected to a database 90 of external authorities. The external authorities may be, for example: police, fire services, municipal, health, first aid, road infrastructure companies, military, etc. The information that vehicle subsystem 20 and remote central server 70 share with each other can be: general environmental constant or temporal information, geographical information, road historical information, vehicle trip information of a vehicle connected to the system of the present invention, vehicle historical profile of a vehicle connected to the system of the present invention, and any relevant information which can be received from the external authorities.

It should be understood that the environment 1 is an exemplary environment which in reality changes all the time relatively to the moving vehicle 2. Generally, environment 1 comprises all the objects and features that could influence on the driving behavior of driver, 5 and consequently the situation of vehicle 2. Moreover, it would be appreciated that though FIG. 1 shows only a single vehicle equipped with a vehicle subsystem, a single remote central server, a single obstacle, two responders and a limited number of objects, this is made for purposes of the clarity. In a realistic environment a plurality of vehicles equipped with the system of the present invention could communicate with a plurality of remote central servers. The environment could include a plurality of obstacles and a plurality of responders. The vehicles could access a plurality of servers via one or more wireless communication means substantially simultaneously.

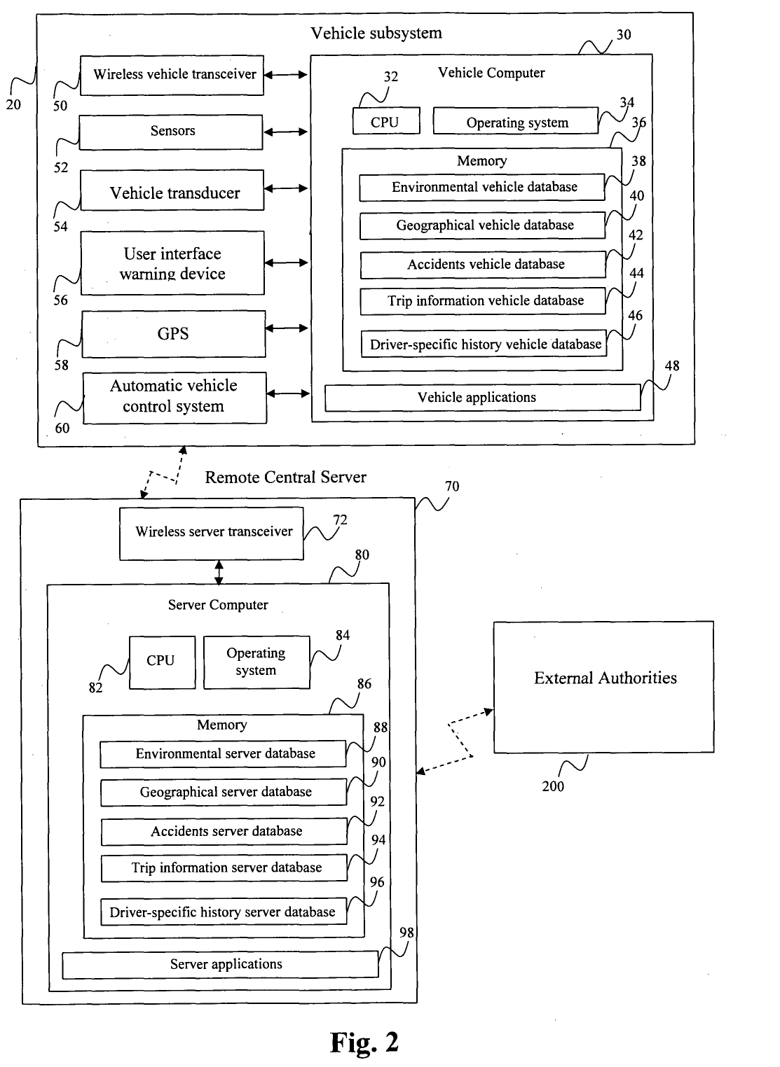

Reference is made now to FIG. 2 where illustrated the preferred embodiment of the present invention. In this figure presented a situation awareness system of a driver of a vehicle. This system comprises two main parts: a vehicle subsystem 20 and a remote central server 70 adapted to be communicatively connected to each other.

The remote central server 70 comprises the following components: a server computer 80 that comprises a CPU 82, a memory 86, and an operating system 84. Furthermore, the remote central server 70 comprises a wireless server transceiver 72, a plurality of server databases within the memory 86 of the server computer 80, and a plurality of server applications 98 within the server computer 80 adapted to manage the plurality of server databases and to control the wireless server transceiver 72.

The plurality of server databases comprises the following databases:
(a) Environmental server database 88 adapted to store objects and features that could influence on the driving behavior of a driver. The environmental server database 88 may comprise information regarding unexpected events on the road such as unexpected obstacles on the road, broken traffic lights, a broken vehicle on the side of the road, outstanding road events, predetermined speed limits, temporary speed limits, traffic conditions, different types of traffic signs, status and location of traffic lights, bridges, exit and entry ramps, blocked lanes, separation lines between lanes, borders of lanes, works on the road, weather-related conditions, temperature limits of the vehicle, safety regulations, driving rules in specific locations, etc.
(b) Geographical server database 90 adapted to store map records. This database comprises the most updated maps of different locations, and can be synchronized with the global positioning system (GPS).
(c) Accidents server database 92 adapted to store the location of past accidents and the number of accidents in the specific location.
(d) Trip information server database 94 adapted to store the trip history of each vehicle that is connected to the system of the present invention, and also to store the identity of the driver that drives the vehicle. The trip information server database 94 may comprises the following records: time-continuous location records of the vehicle, time-continuous speed records of the vehicle, unexpected behavior of the vehicle on the road, the identity of the driver the drives the vehicle, time-continuous records of information received from a plurality of sensors (detailed below), etc. The trip information server database 94 may also be synchronized with the global positioning system (GPS) in order to receive the location, the speed, the direction of the vehicle, etc.
(e) Driver-specific history server database 96 adapted to store the profile of each driver of the vehicle such as: negative driving-related behavior of the vehicle and the driver of the vehicle, past reports of the vehicle and the driver of the vehicle, medical history of the driver and current condition of the driver.

The negative driving-related behavior of the vehicle and of the driver of the vehicle in the driver-specific history server database 96 can be updated from the trip information server database 94.

The vehicle subsystem 20, which is adapted to be installed in a vehicle, comprises the following components: a vehicle computer 30 having a CPU 32, a memory 36, and an operating system 34. Furthermore, the vehicle subsystem 20 comprises a wireless vehicle transceiver 50 adapted to communicate with at least one remote central server 70 and more specifically with a wireless server transceiver 72 of at least one remote central server 70, a plurality of vehicle databases within the memory 36 of the vehicle computer 30, and a plurality of vehicle applications 48 within the vehicle computer 30 adapted to manage the plurality of vehicle databases and to control the wireless vehicle transceiver 72. Furthermore, the vehicle subsystem 20 comprises a plurality of sensors 52 adapted to collect information about the state of the vehicle, to identify the driver, and to collect information about the state of the driver, and all that in real-time. The term ‘state of vehicle’ may be related to: the speed of the vehicle, proximity of the vehicle to other vehicles from all the sides of the vehicle, technical parameters relevant to the element of the vehicle, readings of the standard sensors located within the vehicle, etc. The term ‘state of driver’ may be related to: the health status of the driver, presence of the driver's hands on the wheel, the presence of other passengers in the vehicle, sleepiness of the driver, whether the driver has drunk alcohol prior to entering the vehicle, etc. The sensors 52 incorporated within the vehicle can be standard sensors which appear in every standard vehicle, and also can be additional sensors which are added to the vehicle as part of the system of the present invention. The sensors 52 can be the following: driver identification sensors, speed sensors, sensors to measure speed of proximal vehicles, IR sensors, proximity sensors adapted to be located in the perimeter of the vehicle, sensors of air pressure in the wheels, air-bag activation sensors, sensors to detect presence of alcohol in the air of the vehicle, sensors to verify that both hands are one the steering wheel of the vehicle, temperature sensors on the steering wheel of the vehicle, movement sensors, temperature sensors within the vehicle, at least one video camera, pressure sensors within at least one seat of the vehicle to detect presence of passengers, sensors to notify regarding a periodical care of the vehicle, belt sensors, fuel sensors, water/oil sensors, sensors to analyze the air in the vehicle to detect a sleepy and/or a drunk driver.

The plurality of vehicle databases comprises the following databases:
(a) Environmental vehicle database 38 adapted to store objects and features that could influence on the driving behavior of a driver and the information received from the environmental responders. The environmental server database 38 may comprise information regarding unexpected events on the road such as unexpected obstacles on the road, broken traffic lights, a broken vehicle on the side of the road, outstanding road events, predetermined speed limits, temporary speed limits, traffic conditions, different types of traffic signs, status and location of traffic lights, bridges, exit and entry ramps, blocked lanes, separation lines between lanes, borders of lanes, works on the road, weather-related conditions, temperature limits of the vehicle, driving rules in specific locations, etc.
(b) Geographical vehicle database 40 adapted to store map records. This database comprises the most updated maps of different locations, and can be synchronized with the global positioning system (GPS).
(c) Accidents vehicle database 42 adapted to store the location of past accidents and the number of accidents in the specific location.
(d) Trip information vehicle database 44 adapted to store the trip history of each vehicle that is connected to the system of the present invention, and also to store the identity of the driver that drives the vehicle. The trip information vehicle database 44 may comprises the following records: time-continuous location records of the vehicle, time-continuous speed records of the vehicle, unexpected behavior of the vehicle on the road, the identity of the driver the drives the vehicle, time-continuous records of information received from a plurality of sensors (detailed below), etc. Trip information vehicle database 44 is the ‘black box’ of the vehicle, and therefore is collects all the information regarding the state of the vehicle, and all the time.
(e) Driver-specific history vehicle database 46 adapted to store the profile of each driver of the vehicle such as: negative driving-related behavior of the vehicle and the driver of the vehicle, past reports of the vehicle and the driver of the vehicle, medical history of the driver and current condition of the driver.

The vehicle subsystem 20 is further adapted to register the collected information from the sensors 52 in the trip information vehicle database 44.

The vehicle subsystem 20 further comprises a GPS navigation system 58, a vehicle transducer 54 to interrogate external environmental responders about the state of the environment.

Furthermore, in the preferred embodiment of the present invention, the vehicle subsystem 20 comprises a situation assessment application which is part of the vehicle applications 48 adapted to collect and analyze the collected information from the plurality of sensors 52, the GPS 58, the databases of the remote central server, and the plurality of vehicle databases, and to register the conclusions of the analyzed information into data structures. The situation assessment application is based on at least one situation assessment mathematical function. The situation assessment mathematical function is adapted to weight all the information received from many sources, wherein important factors receive high weight, and unimportant factors receive low weight. When a specific measured or received value of a specific factor is higher than a predetermined threshold of the specific factor, the weight of the value is raised, for example, according to the ration between the measured or received value of the factor and its predetermined threshold. In a preferred embodiment of the invention, the situation assessment mathematical function may comprise predetermined threshold values of the different factors in the data structures. The threshold values may be registered in the vehicle databases. For example, when a proximity sensor detects that the vehicle is too close to another vehicle located in front of the vehicle, the measured value of the proximity factor received from the proximity sensors will have a high weight. In a preferred embodiment of the invention, the situation assessment mathematical function may comprise predetermined threshold values of the different factors in the data structures.

The remote central server 70 and the vehicle subsystem 20 further comprise synchronization applications as part of the vehicle application 48 and the server application 98. The synchronization applications are adapted to synchronize the vehicle databases with the server databases in a predetermined time interval, according to a predetermined radius around the vehicle, or according to a specific important and urgent event, such that at least one of the following operations is performed: (a) the environmental vehicle database 38 is synchronized with the environmental server database 88, (b) the geographical vehicle database 40 is synchronized with the geographical server database 90, (c) the accidents vehicle database 42 is synchronized with the accidents server database 92, (d) the trip information vehicle database 44 is synchronized with the trip information server database 94, (e) the driver-specific history vehicle database 46 is synchronized with the driver-specific history server database 96.

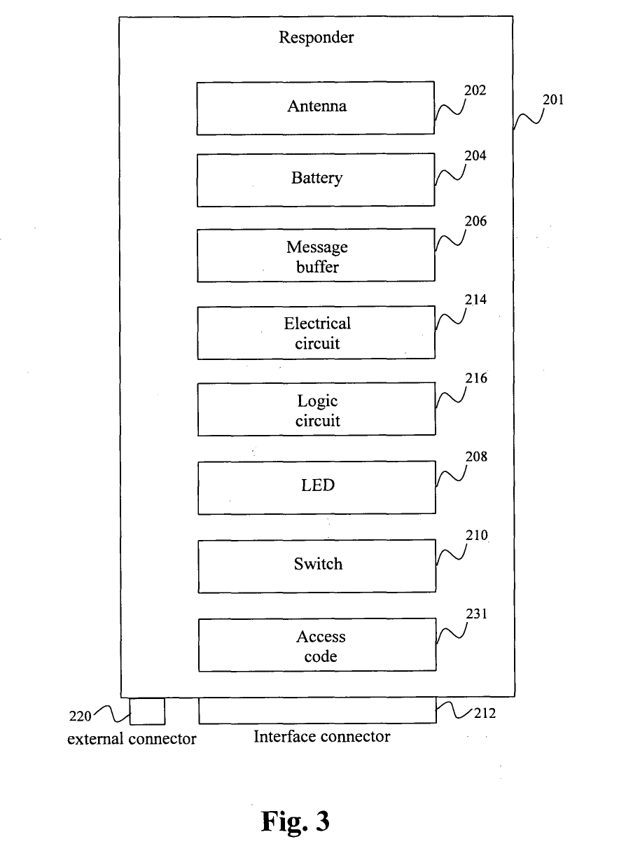

Reference is made now to FIG. 3 where illustrated an external environmental responder 201 removably attached to specific objects in the environment. Responder 201 can be permanent, temporary, fixed, or mobile. Responder 201 is adapted to respond to an interrogating signal generated by the vehicle transducer 54 and to provide information regarding it is attached to. The objects to witch the responders can be attached can be for example: standard road components, traffic signs, traffic lights, landscape features, components in the road geometry, borders of lanes, temporal vehicles, man-made or natural features in the environment, geographic features, road-related features, etc. Thus, for example, responder 201 could be placed at a turn-off to a service area, a rest area, a historical monument, a caravan site and the like. Responder 201 can be of a moveable type such as for example a unique responder 201 which is placed on a vehicle crash site by the proper authorities such as the police, fire services, paramedics or the like. Responder 201 also could be mobile and could be installed in different type of vehicles such as police vehicles, heavy equipment vehicles, school buses and the like. Responder 201 includes one or more antennas 202 to receive signals from vehicle transducer 54 and to transmit information in response, a battery 204 to provide power to the electrical components thereof, a manual switch 210 to deactivate it, one or more LEDs 208 for diagnostic of location purposes, electrical circuitry 214 required for the proper operation of the responder 201, a responder interface connector 212 that enable connection to a programming device such as a laptop computer or a PDA device in order to enable update or creation of a content or an access code 230 included within the response message, logical circuits 216 for storing a simple program that controls the operation of the transducer 201, an access code 230 to hold a specific access code and a response message buffer 206 to hold the content of a responding message. Responder 201 may also be connected to other electrical devices such as traffic lights in order to transmit the status of the electrical device. The connection to the electrical device can be done through connector 220.

The information received from the responders 201 is registered in the environmental vehicle database 38. The data in environmental vehicle database 38 may be continuously compared to the data in the environmental server database 88, and in case of detection of previously unknown information in one of the databases, the unknown information is registered in the suitable database. By that, when the vehicle subsystem detects new responder which was not known in the system, the central server is updated with the new information. After that, the other vehicles connected to the central server may receive the information regarding the new responder.

In a preferred embodiment of the invention, a main component of the system of the present invention within the vehicle subsystem is a user interface warning device 56 (FIG. 2) which is adapted to present the data structures in a user friendly manner, and thereby to enhance the situation awareness of the driver. The user interface warning device 56 can be for example a small LCD screen with a map which is received from the GPS system, and with a massage window. Important information saved in the data structures will be translated to a written massage. For example, the system can write in the massage window: “Be aware, you are now in an area with a history of X accidents, slow down!”. The user interface warning device 56 can also comprise five-level visual colored indicators to express to severity of the situation. For example, the first level may be a green blinking indicator which is a recommendation to the driver as he is about to enter to a dead end street, any reverse driving or permitted detour, as well as any warning pertaining to the safety of the vehicle, e.g., oil or water leakage, an almost empty gas tank, something wrong with the wheels, etc. The second level may be a blue blinking indicator that serves as an instruction to the driver, activated for example when the vehicle goes off the road onto the shoulders of the road, or a safety belt is not fastened, or the driver is not holding the steering wheel with both hands, the vehicle performs a repeated weaving from lane to lane in a short period of time, etc. The third level may be a yellow blinking indicator that is activated when the driver fails to maintain a safe distance from the vehicle in front, when driving along the shoulders for an extended period of time, etc. The fourth level may be a red blinking indicator that is an instruction to the driver in case of a violation of the traffic regulations such as crossing separation line, exceeding the speed by more than 20 Kmph., failure to give right of way to another vehicle, not allowing a pedestrian to cross the road, etc. The fifth level may be a black blinking indicator that is activated, for example, upon crossing a junction in a red light, disregarding a ‘stop’ sign, drunkenness of the driver while driving, when the vehicle exceeds the speed limit by more than 40 Kmph., etc. The user interface warning device 56 can also comprise five-level sound indicators which are adapted to warn the driver of the vehicle and to enhance his situation awareness. The sound indicators may be output threw the sound system of the vehicle or an internal sound system in the user interface warning device 56. The level of the sound indicators may be determined in the same method as the five-level visual colored indicators. It is also in the scope of the present invention that the level of the sound can vary according the profile of the driver as registered in the driver-specific history vehicle database 46. For example, a young drive will hear a lower level of warning sound than an old driver. For another example, the level of the sound may vary according to the health conditions of the driver. Moreover, if the system of the present invention detects a sleepy condition of the driver, a louder warning sound will be activated.

In another aspect of the invention, the wireless server transceiver 72 is adapted to establish and maintain wireless communication between the remote central server 70 and (a) at least one vehicle 30, (b) other at least one remote server (not shown), and (c) external authorities 200. The external authorities 200 may be for example: police, fire services, municipal, health, first aid, road infrastructure companies, military, etc. Moreover, the server databases are able to be synchronized with databases related to the external authorities. For example, in case of an accident in a specific location, the environmental server database 88 will be updated by the database of the police.

In another aspect of the invention, the situation assessment mathematical function is adapted to assess the situation by using the statistics of accidents received from the external authorities 200.

This statistics is registered in the accidents vehicle database 42 and in the accidents server database 92.

In another aspect of the invention, the vehicle subsystem 20 can be activated and deactivated by the driver, when two consequent pressings on the winker of the vehicle are performed. In a specific embodiment of the present invention, the vehicle subsystem 20 can also be activated by police of first aid external authorities.

In the preferred embodiment of the present invention, the situation awareness system can comprise an automatic vehicle control system adapted to limit and to reduce the speed of the vehicle (or even break the vehicle) in an emergency case which is detected by the situation assessment application. When such an event is detected, the driver could be notifies that an automatic operation is going to occur, and the automatic vehicle control system can take partial or full control of the vehicle and change the state of the vehicle according to predetermined protocols. These protocols may be correlated with the five-levels of warnings mentioned above. For example, if there is an obstacle in 100 meters from the vehicle, and the driver does not respond the warnings on the warning device, the system will reduce the speed of the vehicle automatically (or even break the vehicle). For another example, the automatic vehicle control system may take control over the car in case of a ‘stop’ traffic sign, if the driver will not stop the car by himself. According to a specific embodiment of the invention, the automatic vehicle control system is adapted to limit and to reduce the speed of the vehicle when the speed of the vehicle, measured by the speed sensor, is over the speed limit registered in the environmental vehicle database. This can be performed when the value of the speed of the vehicle registered in the data structures is higher than the predetermined speed limit in the specific road. In this case, the situation assessment application will decide that the speed factor is too high, and present to the driver a warning. The warning may be the fourth level red blinking indicator mentioned above. In this case, the automatic vehicle control system will reduce the speed of the vehicle automatically to the allowed speed. In another example, the speed of the vehicle may be reduced by the automatic vehicle control system when the vehicle is located in an area with a long history of accidents. In this case, if the situation assessment application detects that the number of past accidents is higher than a predetermined threshold, as registered in the accidents vehicle database 42, the situation assessment application may conclude that the situation is not safe, and therefore warn the driver, and also, optionally, reduce the speed of the vehicle automatically, if needed.

In a preferred embodiment of the invention, the situation assessment application of the vehicle subsystem may also comprise an ability to calculate the risk of by-passing other vehicles in a specific moment and a specific location. This can be performed by weighting all the relevant factors which are related to the surrounding of the vehicle, such as: the speed of the vehicle, the speed of other vehicles located around the vehicle (as received from the remote control server, or as measured by speed sensors located in the surrounding of the specific vehicle), the proximity of the vehicle to other vehicles, etc.

In a preferred embodiment of the invention, situation assessment application is adapted to detect the distance between at least two vehicles in the multi-vehicle environment by using means such as: the geographical server database, the trip information server database, the environmental server database, at least one proximity sensor, etc.

In a preferred embodiment of the invention, the server applications 98 within the server computer 80 may further comprises a driver assessment application adapted to: (a) assess the behavior of the driver or the vehicle on the road by analyzing the plurality of server databases (b) inform the driver of the vehicle in case of a negative behavior on the road (c) inform the police in case of negative behavior of the vehicle or of the driver on the road. In a preferred embodiment of the invention, the driver assessment application is further adapted to analyze the plurality of server databases to understand the circumstances which led to an accident and to receive the history of the vehicle or the driver. The driver assessment application may further be able to inform an insurance company regarding the assessed behavior of the driver or of the vehicle. This might be user for reduction of insurance prices for careful drivers, and might be a trigger to install the system.

In a preferred embodiment of the invention, the vehicle applications may further comprises an automatic parking system. The automatic parking system is adapted to: (a) detect that the vehicle is parking in a parking place by analyzing the trip information vehicle database 44 (b) inform the driver of the vehicle regarding the legality of the parking of the vehicle (c) charge a predetermined parking-account of the driver in case of legal parking (d) inform parking authorities in case of illegal parking.

In a specific embodiment of the invention, the trip information server database 94 and the trip information vehicle database 44 can register message received from a first vehicle, the message can be transmitted to a second vehicle and presented to the driver of the second vehicle by the user interface warning device 56. This massage transfer between vehicles is performed according to the authorizations of the driver or the vehicles of both vehicles. The message may be received from a first vehicle by an input subsystem integrated within the user interface warning system 56. The message may be for example, an order to stop the car made by the police, notice or request regarding change of lanes by a specific vehicle or when a vehicle wants to by-pass informed vehicle.

In a specific embodiment of the invention, the system of the present invention may allow the driver of the vehicle to receive driving directions by calling to a customer center connected to the central server 70, or directly through the user interface warning device 56.

In a specific embodiment of the invention, the situation awareness system of the present invention further comprises a parking assisting application adapted to assist the driver of the vehicle to park the vehicle by using for example, the proximity sensors.

In a specific embodiment of the invention, the situation awareness system of the present invention may comprise an automatic accident reporting system adapted to detect that an accident has occurred with the vehicle by analyzing the server databases and to report the authorities regarding accident events of the vehicle, the automatic accident reporting system further adapted to report details regarding the accident.

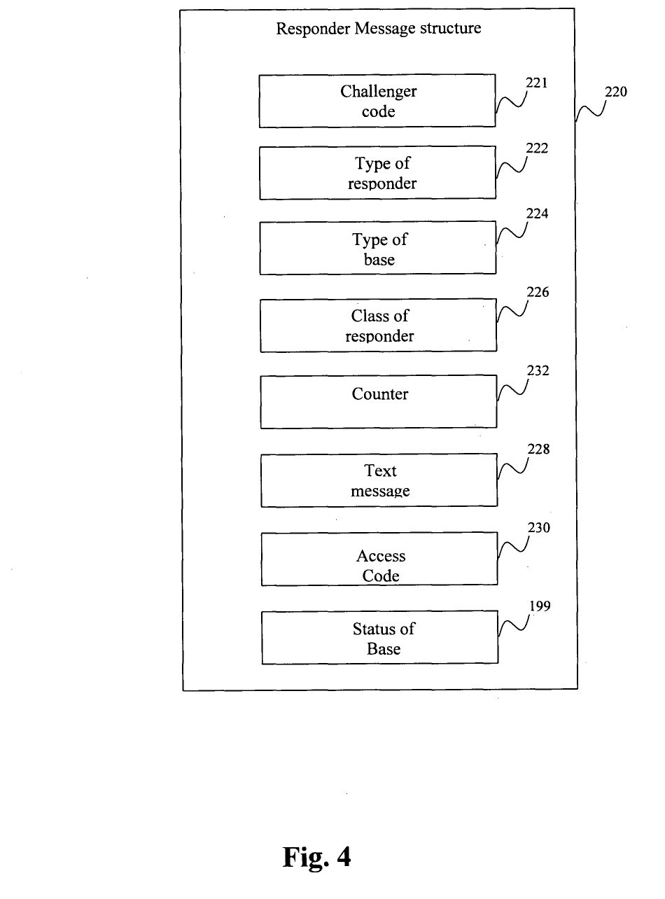

Reference is made now to FIG. 4 where illustrated a schematic block diagram showing the data fields of the responder's message structure 220. A responder message 220 could include: a type of responder field 222, a type of base field 224, a status of the base field 199, a class field 226, a counter field 232 and a text message field 228. When a vehicle transducer 54 interrogates a responder 201 by transmitting a frequency-specific interrogation field towards the responder 201 then the responder 201 reacts by activating its antenna 202 and sending the message that is stored in the message buffer 206. The vehicle transducer 54 receives the message and passes it to an external responder handler application which is one the vehicle application 48. This application deconstructs the message, and registers the massage in the environmental vehicle database 38. The type of responder field 222 could include a code indicating the type of the responder such as fixed, mobile, permanent or temporary. The meaning of this field is self-evident. The class field 226 includes a code that indicates the class of the responder 201 such as public, private, military, emergency, commercial or the like. A public class responder 201 could respond to any vehicle transducers 54. A military and police class responder 201 responds only if the challenge includes a specific access code. A private responder 201 could be placed as a direction indicator to location where a private event such as a wedding or a private party takes place. The driver of vehicle could instruct the transducer 54 to ignore private responder messages or “listen” to them specifically. Alternatively a private responder 201 could include a particularly allocated access code 231 and the transducer could search for a responder 201 having that private code. Public responders 201 are generally disposed before potentially dangerous locations for the vehicle such as intersections without traffic lights, railway crossings, movable bridges, road works, street vehicle crossings, open manholes and the like. The base status field 199 could include data concerning the status of a traffic light, for example, when the responder 201 is attached to the traffic light the base status 199 could store “1” for red, “2” for green, “3” for yellow after red and “4” for yellow after green. Other types of bases could have different status indicators. Counter field 230 is holding the results of an accumulator device that is counting various objects, events or the like. In the preferred embodiment of the present invention counter 230 is indicating the number of challenges received for a given period. When the counter value is embedded in the responding message it could be used in a variety of ways such as considering it as a factor in road congestion calculations or the like. The value of the counter field 230 could be set to zero when required through the above mentioned responder interface. Text message field 228 could store a short message for displaying on the user interface warning device 56. For example, commercial class responders 201 could be placed at the entryway of a commercial firm and the text message therein could include a short advertisement for the firm. Commercial messages are identified by class and could be filtered out in accordance with the instruction of the driver. In an alternative embodiment of the invention private mobile responders 201 could be put on the clothing worn by a child or a disabled person such as a visually challenged person. A set of sequentially following evenly paced responders 201 could be laid down temporarily in order to direct the driver of vehicle to a largely unknown location in which a festive event is taking place. In certain areas such as wild life sanctuaries responders 201 could be placed on the body of an animal to reduce the likeness of accident involving a vehicle with an animal. A plurality of uses is contemplated for the utilization of responders. Eventually a vehicle equipped with the system and method for vehicle safety and a transducer in a responder-rich environment could become easily a mobile platform for the collection, processing and transmitter of information.

It is within the scope of the present invention that external authorities (e.g., police) are able to follow the vehicles which are connected to the system of the present invention, and thereby catch suspected vehicles or criminal drivers. It is also within the scope of the present invention that in case of a legal trial, the information gathered in the server databases may be used for investigation of accidents.

It is within the scope of the present invention that the server databases may comprise an initial data which is registered within the server databases. For example, the geographical server database may comprise maps, and the environmental server database may comprise traffic rules, etc.

It is also within the scope of the present invention that if an extraordinary temperature within said vehicle is detected, the driver may be informed about that.

It is also within the scope of the present invention that the vehicle subsystem may warn the driver of the vehicle when a criminal driver is on the road by analyzing the driver-specific history database.

Changes may be made in the construction and operation of various components, elements and methods described herein and changes may be made in the steps or the sequence of the steps of the methods described herein without departing from the spirit and scope of the invention as defined in the following claims.

1-42. (canceled)

43. A situation awareness system of a driver of a vehicle in a multi-vehicle environment, said system comprising:
a. at least one remote central server communicatively connected to said at least one vehicle, said server comprising:
i. a server computer comprising a CPU, a memory, and an operating system;
ii. at least one wireless server transceiver;
iii. a plurality of databases within said server computer; and,
iv. a plurality of applications within said server computer adapted to manage said plurality of server databases and to control said wireless server transceiver;
b. at least one vehicle subsystem installed in a vehicle with a driver, said subsystem comprising:
i. an vehicle computer having a CPU, a memory, and an operating system;
ii. a plurality of sensors adapted to collect information about the state of said vehicle, to identify said driver, and to collect information about the state of said driver;
iii. a plurality of databases within said vehicle computer;
iv. at least one vehicle transducer to interrogate external environmental responders about the state of the environment;
v. a wireless vehicle transceiver adapted to communicate with said at least one remote central server;
vi. a plurality of vehicle applications within said vehicle computer adapted to manage said plurality of vehicle databases and to control said wireless vehicle transceiver; and,
vii. a situation assessment application adapted to collect and analyze the collected information from said plurality of sensors, said databases of said remote central server, and said plurality of databases, and to register said analyzed information into data structures; wherein said situation assessment application is based on at least one situation assessment mathematical function; wherein said vehicle subsystem further comprises a user interface warning device which is adapted to present said data structures in a user friendly manner, and thereby to enhance the situation awareness of said driver.

44. The situation awareness system of claim 43, wherein said wireless server transceiver is adapted to establish and maintain wireless communication between said remote central server and (a) said at least one vehicle, (b) other at least one remote server, and (c) external authorities.

45. The situation awareness system of claim 44, wherein said situation assessment mathematical function is adapted to assess the situation by using the statistics of accidents received from said external authorities; said statistics is registered in said server databases and said vehicle databases.

46. The situation awareness system of claim 43, further comprising a plurality of external environmental responders removably attached to specific objects in said environment, wherein said responders are adapted to respond to an interrogating signal generated by said vehicle transducer and to provide information regarding said objects wherein said objects are selected from a group consisting of: standard road components, traffic signs, traffic lights, landscape features, components in the road geometry, borders of lanes, temporal vehicles, or any combination thereof, and further wherein said situation assessment application is adapted to detect the distance between at least two vehicles in said multi-vehicle environment by using means selected from a group consisting of: said geographical server database, said trip information server database, said environmental server database, said at least one proximity sensor, or any combination thereof.

47. The situation awareness system of claim 43, wherein said plurality of server and vehicle databases are selected from a group consisting of: (a) an environmental database adapted to store objects and features that could influence on the driving behavior of said driver, (b) a geographical database adapted to store map records, (c) accidents database adapted to store the location of past accidents and the number of accidents in said location, (d) a trip information database adapted to store the trip history of said vehicle and said driver, and (e) a driver-specific history database to store the profile of each said driver of said vehicle, and wherein said environmental server database comprises information selected from a group consisting of: outstanding road events, predetermined speed limits, temporary speed limits, traffic conditions, different types of traffic signs, traffic lights, bridges, exit and entry ramps, blocked lanes, separation lines between lanes, borders of lanes, works on the road, unexpected obstacles on the road, weather-related conditions, temperature limits of said vehicle or any combination thereof.

48. The situation awareness system of claim 47, wherein said driver-specific history database comprises information selected from a group consisting of: negative driving-related behavior of said vehicle and said driver, past records of said vehicle and said driver, medical history and current condition of said driver, or any combination thereof, and wherein said trip information database comprises information selected from a group consisting of: time-continuous location records of said vehicle, time-continuous records of information received from said plurality of sensors, or any combination thereof.

49. The situation awareness system of claim 47, wherein said plurality of databases are able to be synchronized with databases related to authorities selected from a group consisting of: police, fire services, municipal, health, first aid, road infrastructure companies, military, or any combination thereof.

50. The situation awareness system of claim 47, wherein said environmental database comprises the geographical location of information selected from a group consisting of: outstanding road events, predetermined speed limits, temporary speed limits, traffic conditions, different types of traffic signs, traffic lights, bridges, exit and entry ramps, blocked lanes, separation lines between lanes, borders of lanes, works on the road, unexpected obstacles on the road, weather-related conditions, or any combination thereof and further wherein said information regarding said objects received from said responders is compared to the data in said environmental database, and in case of detection of previously unknown information regarding said objects, said unknown information is registered in said environmental database, and further wherein said trip information database comprises information selected from a group consisting of: time-continuous location records of said vehicle, time-continuous records of information received from said plurality of sensors, or any combination thereof.

51. The situation awareness system of claim 47, wherein said driver-specific history database comprises information selected from a group consisting of: negative driving-related behavior of said vehicle or said driver, past records of said vehicle or said driver, medical history and current condition of said driver, or any combination thereof.

52. The situation awareness system of claim 47, wherein said central server and said vehicle subsystem further comprise a synchronization application adapted to synchronize said databases in a predetermined time interval, according to a predetermined radius around said vehicle, or according to a specific important event, such that at least one of the following operations is performed: (a) said environmental databases are synchronized, (b) said geographical databases are synchronized, (c) said accidents databases are synchronized with said accidents server database, (d) said trip information vehicle database is synchronized with said trip information server database, (e) said driver-specific history vehicle database is synchronized with said driver-specific history server database.

53. The situation awareness system of claim 43, wherein said plurality of sensors is selected from a group consisting of: driver identification sensor, at least one speed sensor, at least one proximity sensor, sensors of air pressure in the wheels, at least one air-bag activation sensor, at least one sensor to detect presence of alcohol in the air of said vehicle, sensors to verify that both hands are one the steering wheel of said vehicle, at least one temperature sensor, at least one video camera, at least one pressure sensor within at least one seat of said vehicle to detect presence of a passenger, sensors to notify regarding a periodical vehicle of said vehicle, belt sensors, fuel sensor, water/oil sensor, at least one sensor to analyze the air in said vehicle to detect a sleepy and/or a drunk driver and wherein said vehicle subsystem is further adapted to register said collected information from said plurality of sensors in said trip information vehicle database.

54. The situation awareness system of claim 47, further comprising a GPS navigation system, wherein situation assessment application is further adapted to collect and analyze the collected information from said GPS navigation system; further wherein said GPS navigation system is adapted to be synchronized with said geographical database.

55. The situation awareness system of claim 43, wherein said vehicle subsystem is adapted to be at least partially activated and deactivated by external authorities selected from a group consisting of: police, fire services first aid, or any combination thereof.

56. The situation awareness system of claim 43, further comprising an automatic vehicle control system adapted to limit and to reduce the speed of said vehicle in an emergency case which is detected by said situation assessment application, wherein said state of vehicle is automatically changed according to said emergency case and further wherein said automatic vehicle control system is adapted to limit and to reduce the speed of said vehicle when the speed of said vehicle, measured by said speed sensor, is over the speed limit registered in said environmental database and further wherein said automatic vehicle control system is adapted to limit and to reduce the speed of said vehicle when said vehicle is located in an area with a number of past accidents which is higher than a predetermined accidents threshold, according to the registered past accidents in said accidents database.

57. The situation awareness system of claim 43, wherein said applications within said server computer further comprise an emergency condition assessment application adapted to detect emergency conditions of said vehicle by analyzing said trip information database and wherein said situation assessment application is further adapted to calculate the risk of by-passing other vehicles.

58. The situation awareness system of claim 43, wherein said plurality of applications within said server computer further comprises a driver assessment application adapted to: (a) assess the behavior of said driver or said vehicle on the road by analyzing said plurality of databases (b) inform said driver of said vehicle in case of a negative behavior on the road (c) inform the police in case of negative behavior of said vehicle or of said driver on the road.

59. The situation awareness system of claim 43, further comprising an automatic accident reporting system adapted to detect that an accident has occurred with said vehicle by analyzing said databases and to report said authorities regarding accident events of said vehicle, said automatic accident reporting system further adapted to report details regarding said accident.

60. A method for enhancement of situation awareness of a driver of a vehicle in a multi-vehicle environment, said method comprising:
i. obtaining a situation awareness system comprising a vehicle subsystem and a remote central server;
ii. identifying the driver of said vehicle;
iii. collecting information by a plurality of sensors, said information is about the state of said vehicle and about the state of said driver, and storing said information in databases in said vehicle and said server;
iv. synchronizing the databases in a predetermined time interval by a synchronization application, according to a predetermined radius around the vehicle, or according to a specific important and urgent event,
v. managing said plurality of server databases and said plurality of databases and controlling said wireless server transceiver and said wireless vehicle transceiver by said server applications and said vehicle applications;
vi. interrogating external environmental responders about the state of the environment and registering the received information from said responders in said databases;
vii. analyzing the collected information received from said plurality of sensors, in said databases and registering the analyzed information into data structures, wherein said step of analyzing is by a situation assessment application based on at least one situation assessment mathematical function;
viii. presenting said data structures in a user friendly manner by a user interface warning device within said vehicle subsystem, and thereby enhancing said situation awareness of said driver.

61. The method for enhancement of situation awareness of claim 60, further comprising a step of establishing and maintaining wireless communication by said wireless server transceiver between said remote central server and (a) said at least one vehicle, (b) other at least one remote server, and (c) external authorities.

62. The method for enhancement of situation awareness of claim 60, further comprising a step of synchronizing said plurality of databases with databases related to authorities selected from a group consisting of: police, fire services, municipal, health, first aid, road infrastructure companies, military, or any combination thereof and further comprising a step of synchronizing said GPS navigation system with a database selected from a group consisting of: said geographical database, said geographical database, or any combination thereof.
